(19) United States
(12) Patent Application Publication
(10) Pub. No.: US 2026/0290844 A1
(43) Pub. Date: Sep. 24, 2026

(54) SECONDARY BATTERY

(71) Applicant: SAMSUNG SDI CO., LTD., Yongin-si (KR)

(72) Inventor: Jin Seon SHIN, Yongin-si (KR)

(21) Appl. No.: 19/284,999

(22) Filed: Jul. 30, 2025

(30) Foreign Application Priority Data
Mar. 20, 2025 (KR) 10-2025-0035660

(51) Int. Cl. H01M 4/70; B60L 50/64; H01M 4/04; H01M 4/66; H01M 10/0585; H01M 50/536

(52) U.S. Cl. CPC H01M 4/70; H01M 4/0404; H01M 4/0435; H01M 4/661; H01M 10/0585; H01M 50/536; B60L 50/64; H01M 2220/20

(57) ABSTRACT

A secondary battery including a case and an electrode assembly accommodated in the case. The electrode assembly may include a first electrode plate, a second electrode plate, and a separator between the first electrode plate and the second electrode plate. At least one of the first electrode plate or the second electrode plate of the electrode assembly may include a conductive base material and an active material applied to the conductive base material. The conductive base material may include a first base material area coated with the active material and having a first thickness and a second base material area not coated with the active material and having a second thickness greater than the first thickness.

### CROSS-REFERENCE TO THE RELATED APPLICATION

The present application claims priority to and the benefit of Korean Patent Application No. 10-2025-0035660, filed on Mar. 20, 2025, in the Korean Intellectual Property Office, the entire disclosure of which is incorporated herein by reference.

### BACKGROUND

### 1. Field

Aspects of some embodiments of the present invention relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery having improved processability and performance by using a conductive base material having a thin thickness at a portion of a base material, on which coating of an active material may be formed, and a thick thickness at a portion of the base material, which may have a tab function. Other aspects of some embodiments of the present disclosure provide a secondary battery in which defects during a process are minimized while increasing in energy density, and welding reliability is secured.

These and other aspects and features of the present disclosure will be described in or will be apparent from the following description of embodiments of the present disclosure.

A secondary battery including a case and an electrode assembly accommodated in the case. The electrode assembly may include a first electrode plate, a second electrode plate, and a separator between the first electrode plate and the second electrode plate. At least one of the first electrode plate or the second electrode plate of the electrode assembly may include a conductive base material and an active material applied to the conductive base material. The conductive base material may include a first base material area coated with the active material and having a first thickness and a second base material area not coated with the active material and having a second thickness greater than the first thickness.

In some embodiments, the active material may be configured to extend from the first base material area to the second base material area.

In some embodiments, a stepped portion may be provided between the first base material area and the second base material area.

In some embodiments, the active material may be configured to cover the stepped portion.

In some embodiments, the active material may include a thickness reduction area having a thickness gradually decreasing from the first base material area to the second base material area.

In some embodiments, a stepped portion, covered by the thickness reduction area, may be provided between the first base material area and the second base material area.

In some embodiments, a width of the thickness reduction area may be from about 8 μm to about 12 μm.

In some embodiments, a ratio of a thickness of the first base material area and a thickness of the second base material area may be from about 0.5:1 to about 0.9:1.

In some embodiments, the conductive base material may include copper or aluminum.

In some embodiments, the conductive base material may include a first surface and a second surface opposite of the first surface. The active material may be applied to at least one of the first surface and the second surface.

In some embodiments, the second base material area may include a base material tab welded to an electrode tab.

In some embodiments, the second base material area may be welded to an electrode tab inside of the case, and wherein the electrode tab extends outside of the case.

A method of manufacturing an electrode plate of an electrode assembly for a secondary battery may include providing a conductive base material, rolling the conductive base material to provide a first base material area having a thickness, with a second base material area being thicker than the first base material area and being outside the first base material area, applying an active material to the first base material area, and slitting and notching the first base material area and the second base material area to form an individual electrode plate.

In some embodiments, applying the active material to the first base material area may further include extending the active material from the first base material area to the second base material area.

In some embodiments, the method may further include providing a stepped portion between the first base material area and the second base material area.

In some embodiments, the method may further include configuring the active material to cover the stepped portion.

In some embodiments, the method may further include configuring the active material to may have a thickness reduction area, where a thickness of the active material gradually decreases from the first base material area to the second base material area.

In some embodiments, the method may further include providing, between the first base material area and the second base material area, a stepped portion, which may be covered by the thickness reduction area.

In some embodiments, the conductive base material may include a first surface and a second surface opposite of the first surface, and the method may further include applying the active material to at least one of the first surface and the second surface.

In some embodiments, the method may further include selecting the conductive base material such that the conductive base material may include copper or aluminum.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a plan view of a secondary battery according to some embodiments.

FIG. 2 illustrates an exploded perspective view of the secondary battery illustrated in FIG. 1, which is turned over.

FIG. 3 illustrates an exploded perspective view of an electrode assembly according to some embodiments.

FIG. 4 illustrates a cross-sectional view of an electrode plate of an electrode assembly according to some embodiments.

FIG. 5 illustrates a cross-sectional view of an electrode plate of an electrode assembly according to some embodiments.

FIG. 6 illustrates a flowchart of a method of manufacturing an electrode plate according to some embodiments.

FIG. 7 illustrates a plan view of an electrode plate in an initial state during a manufacturing process of the method of FIG. 6 according to some embodiments.

FIG. 8 illustrates a plan view of an electrode plate in a second state after the initial state of FIG. 7 during the manufacturing process of the method of FIG. 6 according to some embodiments.

FIG. 9 illustrates a plan view of an electrode plate in a third state after the second state of FIG. 8 during the manufacturing process of the method of FIG. 6 according to some embodiments.

FIG. 10 illustrates a plan view of an electrode plate in a fourth state after the third state of FIG. 9 during the manufacturing process of the method of FIG. 6 according to some embodiments.

FIG. 11 illustrates a plan view of an electrode plate in a fifth state after the fourth state of FIG. 10 during the manufacturing process of the method of FIG. 6 according to some embodiments.

FIGS. 12 and 13 are perspective views showing a battery pack including the secondary battery according to some embodiments.

FIGS. 14 and 15 are perspective and side views showing a vehicle including aspects of an example battery pack according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a). References to two compared elements, features, etc. as being “the same” may mean that they are “substantially the same”.

Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

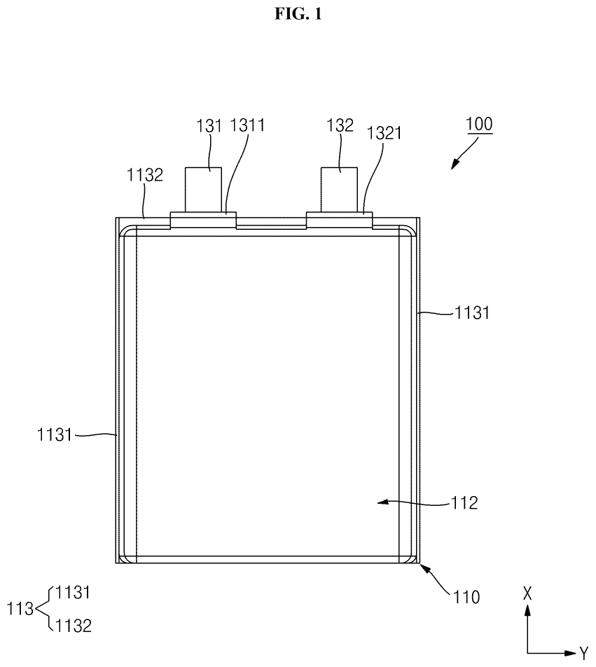

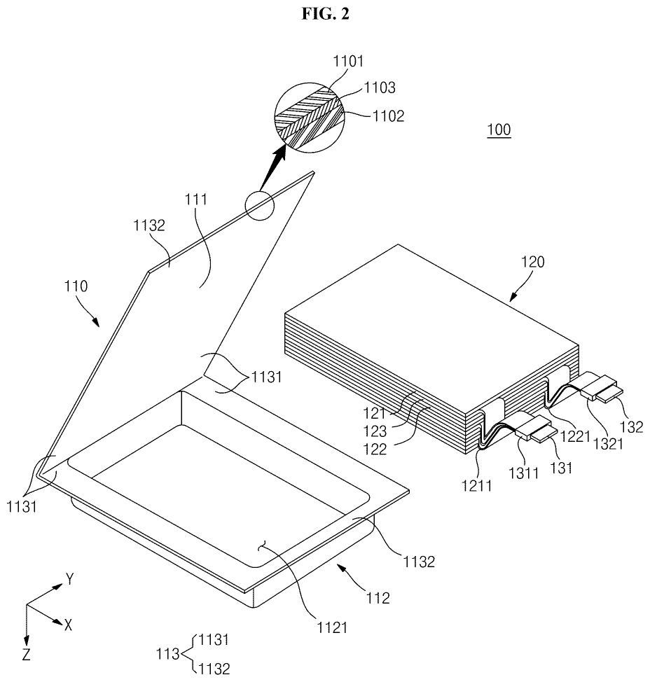

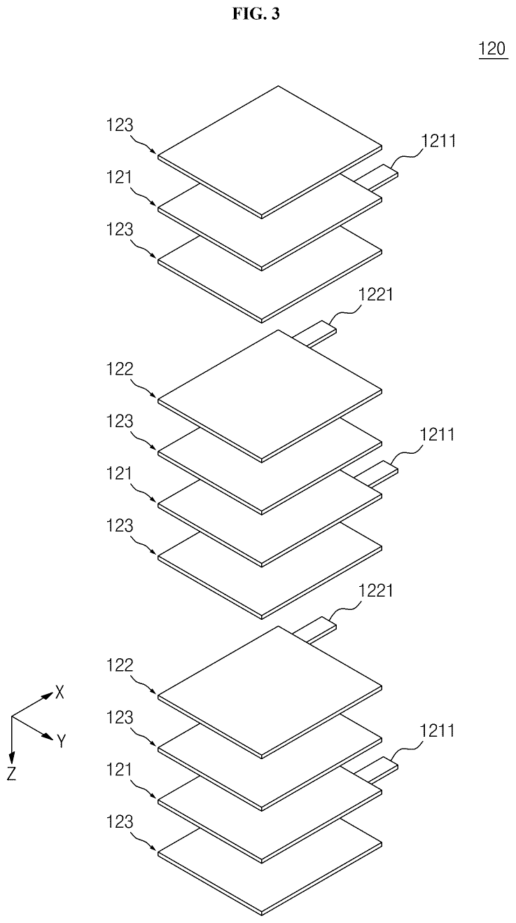

FIG. 1 illustrates a plan view of a secondary battery 100 according to some embodiments. FIG. 2 illustrates an exploded perspective view of the secondary battery 100 illustrated in FIG. 1, which is turned over. FIG. 3 illustrates an exploded perspective view of an electrode assembly 120 according to some embodiments. In some embodiments, the secondary battery 100 according to embodiments may include a case 110, an electrode assembly 120, a first electrode tab 131, and a second electrode tab 132.

The case 110 may be provided to accommodate the electrode assembly 120 and seal an area corresponding to an outside of the electrode assembly 120. The case 110 may include or be referred to as a pouch, an exterior, a can, or a housing. According to some embodiments, the case 110 may be provided as a laminate structure having a first insulating layer 1101, a second insulating layer 1102, and a metal layer 1103 between the first and second insulating layers 1101 and 1102. According to some embodiments, the first insulating layer 1101 may include nylon or polyethylene terephthalate (PET), the metal layer 1103 may include an aluminum thin film, and the second insulating layer 1102 may include casted polypropylene (CPP). In some embodiments, various adhesive layers or functional layers may be added, but descriptions thereof will be omitted so as not to obscure the gist of the present disclosure.

According to some embodiments, the case 110 may include a first case portion 111 and a second case portion 112 of which one side is connected to the first case portion 111 and has a recess 1121 having a predetermined depth to accommodate the electrode assembly 120. According to some embodiments, circumferential areas of the first and second case portions 111 and 112 corresponding to the outside of the electrode assembly 120 may be thermally fused with each other so that the electrode assembly 120 is accommodated inside the case 110 having an approximately pouch or pocket type. According to some embodiments, the thermally fused areas may be the second insulating layers 1102 of the first and second case portions 111 and 112.

According to some embodiments, the case 110 may be provided by bending an approximately intermediate portion of the integrated case 110 having a square plate shape in a longitudinal direction (e.g., an X-axis direction) of one side to constitute the first case portion 111 and the second case portion 112. The recess 1121 having a predetermined depth to accommodate the electrode assembly 120 may be provided in the second case portion 112 through press or drawing processing, and a sealing area 113, which is sealed with the first case portion 111, may be provided on an outer circumference of the recess 1121. According to some embodiments, the recess may also be provided in the first case portion 111. The sealing area 113 may be provided along three sealing parts of the sealing area 113. According to some embodiments, the sealing area 113 may include a pair of lateral sealing parts 1131 provided by sealing the first and second case portions 111 and 112 on an area (e.g., an outer area of a lateral side of the electrode assembly 120) corresponding to the lateral side of the electrode assembly 120 and one front sealing part 1132 provided by sealing the first and second case portions 111 and 112 on an area (e.g., an outer area of a front side of the electrode assembly 120) corresponding to the front side of the electrode assembly 120. In FIG. 1, the pair of lateral sealing parts 1131 are illustrated in a folded state, and in FIG. 2, the pair of lateral sealing parts 1131 are illustrated in a flat state before being folded. Each sealing part of the pair of lateral sealing parts 1131 may be referred to as a wing or a wing sealing area. The front sealing part 1132 may be referred to as a terrace or terrace area.

According to some embodiments, the case 110 may be made of stainless steel. In some embodiments, the sealing of stainless steel may be implemented by laser welding.

The electrode assembly 120 may include, for example, a stack type. According to some embodiments, the stack type electrode assembly 120 may be provided by repeatedly stacking a first electrode plate 121, a second electrode plate 122, and a separator 123 disposed between the first and second electrode plates 121 and 122 in a vertical direction (e.g., a Z-axis direction). According to some embodiments, two or more separators 123 between the first and second electrode plates 121 and 122 on different layers may be independently separated from each other or may be connected to each other and then be bent in a Z shape or an S shape. According to some embodiments, the first electrode plate 121 and the second electrode plate 122 may be alternately disposed between the separators 123 that is bent in the Z shape or the S shape. The separator 123 may be a separation film or an isolation film. According to some embodiments, the separator 123 may include polyethylene, polypropylene, and a porous copolymer of polyethylene and polypropylene. According to some embodiments, the separator 123 may be provided by applying ceramic on a surface thereof to improve thermal performance. The electrode assembly 120 may include or be referred to as an electrode body, an electrode group, a jelly roll, a stack, or a Z stack.

According to some embodiments, a surface area of the separator 123 may be greater than that of each of the first electrode plate 121 and the second electrode plate 122 to prevent an electrical short between the first electrode plate 121 and the second electrode plate 122 from occurring.

According to some embodiments, the first electrode plate 121 may include a first active material layer or a negative electrode active material layer applied on both surfaces or on one surface of a first conductive base material. The first conductive base material may be a conductive metal thin plate, formed of, for example, a copper or nickel foil or mesh. According to some embodiments, the first electrode plate 121 may operate as a negative electrode. According to some embodiments, the first conductive base material may further include a first base material tab 1211 extending outward by a predetermined length without the first active material layer, and the first conductive base material may be welded to the first electrode tab 131. According to some embodiments, instead of the first base material tab 1211, a separate first strip terminal may connect a first non-coating portion (e.g., an area on which the first active material layer is not applied) to the first electrode tab 131. The first conductive base material may be referred to as a first base material, a first current collector, or a first current collector plate. In some embodiments, the first active material layer may be referred to as a first active material, a first active material coating portion, or a first coating portion.

According to some embodiments, the second electrode plate 122 may include a second active material layer or a positive electrode active material layer applied on both surfaces of the second conductive base material provided as a metal thin plate having excellent conductivity, for example, an aluminum foil or mesh. According to some embodiments, the second electrode plate 122 may operate as a positive electrode. The second conductive base material may further include a second base material tab 1221 extending outward by a predetermined length without the second active material layer, and the first conductive base material may be welded to the second electrode tab 132. According to some embodiments, instead of the second base material tab 1221, a separate second strip terminal may connect the second non-coating portion to the second electrode tab 132. The second conductive base material may be referred to as a second base material, a second current collector, or a second current collector plate. In some embodiments, the second active material layer may be referred to as a second active material, a second active material coating portion, or a second coating portion.

As described above, the first electrode tab 131 may be electrically connected to the first base material tab 1211 of the electrode assembly 120. According to some embodiments, the first electrode tab 131 may be ultrasonically welded or laser welded to the first base material tab 1211. As described above, the second electrode tab 132 may be electrically connected to the second base material tab 1221 of the electrode assembly 120. According to some embodiments, the second electrode tab 132 may be ultrasonically welded or laser welded to the second base material tab 1221.

According to some embodiments, the first electrode tab 131 and the second electrode tab 132 may extend outward to a certain length by passing through the case 110 such that each of the first insulating tape 1311 and the second insulating tape 1321 is disposed therebetween.

According to some embodiments, the first electrode tab 131 and the second electrode tab 132 may extend and protrude outward from the case 110 through the front sealing part 1132. In some embodiments, the first insulating tape 1311 and the second insulating tape 1321 may also be coupled to the front sealing part 1132. According to some embodiments, the first electrode tab 131 may be made of copper and nickel, and the second electrode tab 132 may be made of aluminum. According to some embodiments, the electrode tabs may be referred to as a lead, a lead tab, or a cell tab.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

In some embodiments, the structure of the second electrode plate 122 may be similar or the same as a structure of the first electrode plate 121 described below, except that the material composing the first and second electrode plate may be different.

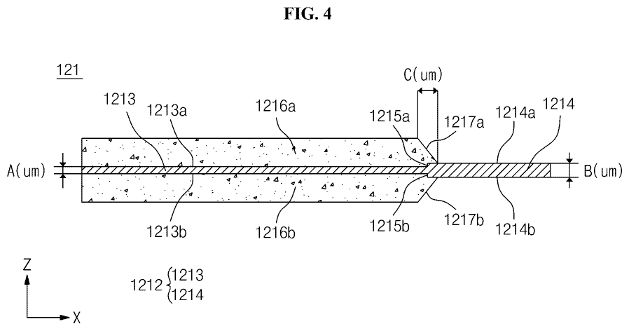

FIG. 4 illustrates a cross-sectional view of the first electrode plate 121 of an electrode assembly 120 according to some embodiments. As illustrated in FIG. 4, the first electrode plate 121 of the electrode assembly 120 may include a conductive base material 1212 and active materials 1216a and 1216b applied on the conductive base material 1212.

According to some embodiments, the conductive base material 1212 may have a thickness from about 8 μm to about 15 μm if it is a positive electrode base material and may have a thickness from about 5 μm to about 12 μm if it is a negative electrode base material. According to some embodiments, if each of the active materials 1216a and 1216b is the positive electrode active material, the each of the active materials 1216a and 1216b may have a thickness from about 50 μm to about 120 μm depending on the energy density, and if each of the active material 1216a and 1216b is the negative electrode active material, each of the active material 1216a and 1216b may have a thickness from about 50 μm to about 100 μm depending on the energy density.

The conductive base material 1212 may include a first base material area 1213 coated with the active materials 1216a and 1216b and having a first thickness and a second base material area 1214 exposed from the active materials 1216a and 1216b and having a second thickness that is thicker than the first thickness.

According to some embodiments, the active materials 1216a and 1216b may be applied to extend from the first base material area 1213 to the second base material area 1214. In some embodiments, the active materials 1216a and 1216b may cover the entire first base material area 1213 and a portion of the second base material area 1214.

According to some embodiments, the conductive base material 1212 may include stepped portions 1215a and 1215b between the first base material area 1213 and the second base material area 1214. Due to the stepped portions 1215a and 1215b, a thickness A of the first base material area 1213 may be less than a thickness B of the second base material area 1214, and the active materials 1216a and 1216b may cover the stepped portions 1215a and 1215b and may also cover even a portion of the second base material area 1214. In some embodiments, the thickness B of the second base material area 1214 may be greater than the thickness A of the first base material area 1213 due to the stepped portions 1215a and 1215b.

According to some embodiments, the active materials 1216a and 1216b may include a thickness reduction areas 1217a and 1217b, each of which has a thickness gradually decreasing from the first base material area 1213 to the second base material area 1214. The stepped portions 1215a and 1215b between the first base material area 1213, and the second base material area 1214 may be covered by the thickness reduction areas 1217a and 1217b. According to some embodiments, a surface of each of the thickness reduction areas 1217a and 1217b may include an inclined surface.

A width C of each of the thickness reduction areas 1217a and 1217b may be from approximately 8 μm to approximately 12 μm. The width C of each of the thickness reduction areas 1217a and 1217b being less than approximately 8 μm may mean that viscosity of active material slurry is relatively high and does not flow well, and, thus, an active material coating process may be difficult in this case. The width C of each of the thickness reduction areas 1217a and 1217b being greater than approximately 12 μm may mean that the viscosity of the active material slurry is relatively low and flows too easily, and, thus, the active material coating process may likewise be difficult. In some embodiments, that the width C of each of the thickness reduction areas 1217a and 1217b is greater than approximately 12μm may mean that the active material is formed with a small thickness and a long length, and thus, lithium precipitation (i.e., a lithium precipitation phenomenon) may occur during an operation of the secondary battery.

In some embodiments, due to the stepped portions 1215a and 1215b between the first base material area 1213 and the second base material area 1214, an dragging phenomenon of the active material, in which a coating thickness is thin, and a length is long at an end of each of the active materials 1216a and 1216b, is suppressed, and thus, the thickness of the active material coating portion may be flat as a whole. In some embodiments, a secondary battery having excellent flatness of the stack electrode assembly including the electrode plate according to the present disclosure and excellent safety and reliability in which the lithium precipitation does not occur may be provided.

According to some embodiments, a ratio of the thickness A of the first base material area 1213 to the thickness B of the second base material area 1214 may be from about 0.5:1 to about 0.9:1. If the ratio of the thickness A of the first base material area 1213 to the thickness B of the second base material area 1214 is less than approximately 0.5, the energy density may be improved, but the first base material area 1213 may be easily torn during a rolling process. If the ratio of the thickness A of the first base material area 1213 to the thickness B of the second base material area 1214 is greater than approximately 0.9, the energy density may not be improved even though the first base material area 1213 is not turn during the rolling process. As described above, the conductive base material 1212 may include copper or aluminum.

In the conductive base materials 1212, the first base material area 1213 may include a first surface 1213a that is approximately flat and a second surface 1213b that is approximately flat and is opposite to the first surface 1213a, and the active materials 1216a and 1216b may be applied to the first and second surfaces 1213a and 1213b, respectively. In some embodiments, in the conductive base may include a first surface 1214a that is approximately flat and a second surface 1214b that is approximately flat and is opposite to the first surface 1214a, and the active materials 1216a and 1216b may be applied to a portion of the first surface 1214a and a portion of the second surface 1214b, respectively.

As described above, due to the stepped portions 1215a and 1215b between the first base material area 1213 and the second base material area 1214, the first surface 1213a of the first base material area 1213 and the first surface 1214a of the second base material area 1214 may have different planes. In some embodiments, a stepped portion 1215a or vertical surface may be provided between the first surface 1213a of the first base material area 1213 and the first surface 1214a of the second base material area 1214. In some embodiments, the second surface 1213b of the first base material area 1213 and the second surface 1214b of the second base material area 1214 may have different planes. In some embodiments, a stepped portion or vertical surface 1215b may be provided between the second surface 1213b of the first base material area 1213 and the second surface 1214b of the second base material area 1214.

According to some embodiments, the second base material area 1214 may be referred to as a base material tab 1211 welded to the electrode tab. The second base material area 1214 or the base material tab 1211 may be ultrasonically welded or laser welded to the electrode tab at the inside of the case, and the electrode tab may extend to an outside of the case.

In some embodiments, because the first base material area 1213 is relatively thin, thicker active materials 1216a and 1216b may be applied to the first base material area 1213 to increase in energy density of the battery. This reduction in thickness of the first base material area 1213 may be suitable for high voltage batteries. In some embodiments, because the second base material area 1214 is relatively thick, welding reliability between the second base material area 1214 and the electrode tab may be improved, and thus, the second base material area 1214 (e.g., the base material tab 1211) may not be disconnected well from the electrode tab after the welding. Thus, because the electrode plate is not electrically separated from the electrode tab, a capacity retention rate of the secondary a battery may be high.

In some embodiments, if applying the active materials 1216a and 1216b, the dragging phenomenon may occur at an edge of each of the active materials 1216a and 1216b, and thus, if the thicknesses of the first and second base material areas 1213 and 1214 are the same, the thickness of each of the active material coating portions 1216a and 1216b may become thinner and longer as each of the active material coating portions goes toward the second base material area 1214 (e.g., the base material tab 1211). However, in some embodiments, because the thicknesses of the first and second base material areas 1213 and 1214 are different (i.e., the thickness of the second base material area 1214 is thicker than that of the first base material area 1213), the dragging phenomenon may not occur at the end of each of the active material coating portions 1216a and 1216b. In some embodiments, the dragging phenomenon in which the thickness becomes thinner, and the length becomes longer at the end of each of the active material coating portions 1216a and 1216b may be suppressed by the relatively thick second base material area 1214 or the stepped portions 1215a and 1215b, and, thus, the lithium precipitation phenomenon may be prevented from occurring.

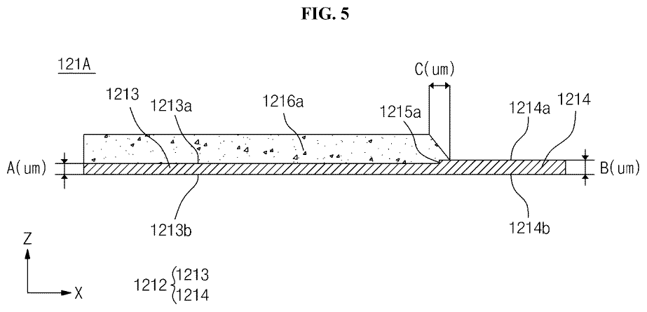

FIG. 5 illustrates a cross-sectional view of an uppermost electrode plate 121A of an electrode assembly 120 according to some embodiments. The uppermost electrode plate 121A illustrated in FIG. 5 may be similar to the first electrode plate 121 illustrated in FIG. 4, except that the active material 1216a may be applied only to one surface of the conductive base material 1212. In some embodiments, the uppermost electrode plate 121A illustrated in FIG. 5 may be disposed at the uppermost and lowermost sides of the electrode assembly 120, and the first electrode plate 121 illustrated in FIG. 4 may be interposed between an uppermost electrode plate 121A and a lowermost electrode plate.

In FIG. 5, the conductive base material 1212 of the first electrode plate 121 may include a first base material area 1213 and a second base material area 1214 that is thicker than the first base material area 1213. The first base material area 1213 may include a first surface 1213a and a second surface 1213b that is opposite the first surface 1213a, and the second base material area 1214 may also include a first surface 1214a and a second surface 1214b that is opposite the first surface 1214a.

According to some embodiments, a stepped portion 1215a may be provided between the first surface 1213a of the first base material area 1213 and the first surface 1214a of the second base material area 1214. According to some embodiments, the second surface 1213b of the first base material area 1213 and the second surface 1214b of the second base material area 1214 may have the same plane. The active material 1216a may be applied to an entire first surface 1213a of the first base material area 1213 and may also be applied to a portion of the first surface 1214a of the second base material area 1214. In some embodiments, the second surface 1213b of the first base material area 1213 and the second surface 1214b of the second base material area 1214 may not be coated with an active material.

In some embodiments, the first electrode plates 121 coated with the active material 1216a on only one surface may be disposed at each of the uppermost and lowermost sides of the stack type electrode assembly 120, respectively, and thus, lithium ions may be efficiently exchanged with the first electrode plates 121, the electrode plates having different polarities.

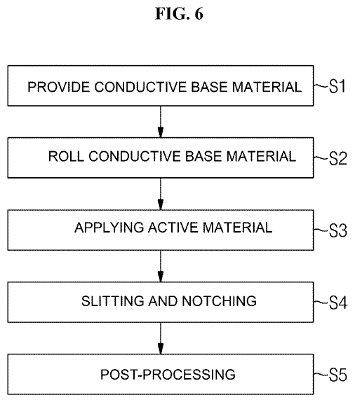

FIG. 6 illustrates a flowchart of a method of manufacturing a first electrode plate 121 according to some embodiments. In FIG. 6, the method of manufacturing the first electrode plate 121 may include a process of providing a conductive base material S1, a process of rolling the conductive base material S2, a process of coating an active material S3, a process of slitting and notching the electrode plate S4, and a post-processing process of the electrode plate S5.

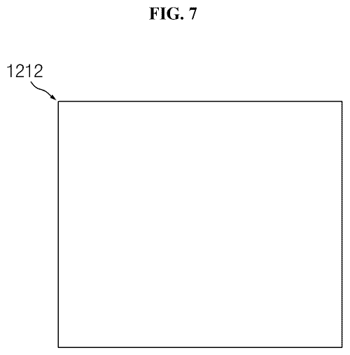

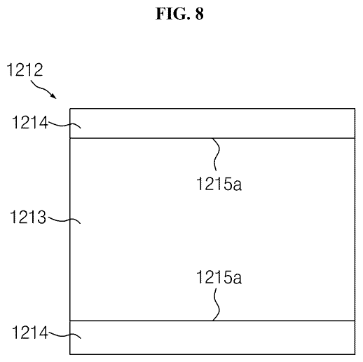

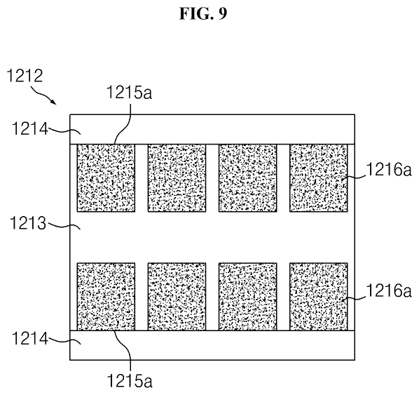

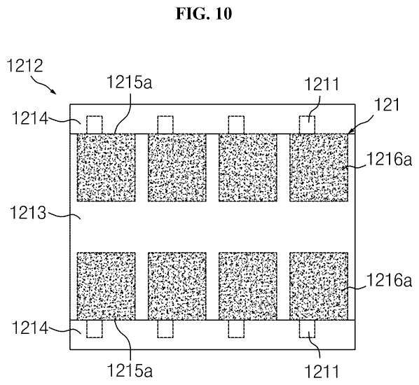

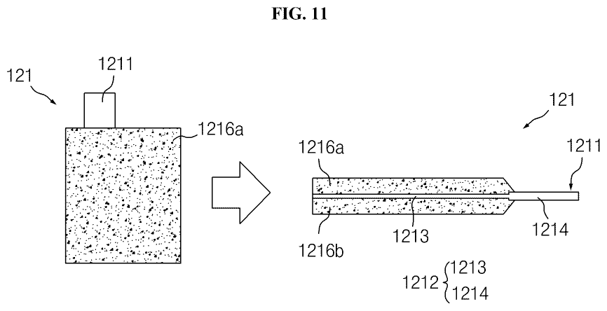

FIG. 7 illustrates a plan view of an electrode plate in an initial state during a manufacturing process of the method of FIG. 6 according to some embodiments. FIG. 8 illustrates a plan view of an electrode plate in a second state after the initial state of FIG. 7 during the manufacturing process of the method of FIG. 6 according to some embodiments. FIG. 9 illustrates a plan view of an electrode plate in a third state after the second state of FIG. 8 during the manufacturing process of the method of FIG. 6 according to some embodiments. FIG. 10 illustrates a plan view of an electrode plate in a fourth state after the third state of FIG. 9 during the manufacturing process of the method of FIG. 6 according to some embodiments. FIG. 11 illustrates a plan view of an electrode plate in a fifth state after the fourth state of FIG. 10 during the manufacturing process of the method of FIG. 6 according to some embodiments.

As illustrated in FIG. 7, in the process of providing a conductive base material S1, a wide conductive base material 1212 having a quadrilateral (e.g., square or rectangular) plate shape may be provided. As described above, if the positive electrode plate is manufactured, an aluminum metal plate may be provided, and, if the negative electrode plate is manufactured, a copper metal plate may be provided. A thickness of the conductive base material 1212 may range from about 8 μm to about 15 μm. According to some embodiments, the conductive base material 1212 may be unwound from a reel and then be provided to a rolling roller.

As illustrated in FIG. 8, in the process of rolling the conductive base material S2, the conductive base material 1212 may be rolled to provide a first base material area 1213 having a first thickness. According to some embodiments, the first base material area 1213 having the first thickness may be provided by rolling the conductive base material 1212 by the rolling roller, the rolling roller having a width less than that of the conductive base material 1212.

According to some embodiments, an unrolled area outside the first base material area 1213 may remain as a second base material area 1214 that is thicker than the first base material area 1213. In some embodiments, a partial area outside the first base material area 1213 may not be rolled over and, thus, may be defined as the second base material area 1214.

According to some embodiments, the relatively thin first base material area 1213 may be provided at an approximately center of the conductive base material 1212, and the relatively thick second base material area 1214 may remain on each of approximately both sides of the conductive base material 1212. Due to the rolling process, stepped portions 1215a and 1215b may be provided between the first base material area 1213 and the second base material area 1214. The first base material area 1213 may be an area to be coated with active materials 1216a and 1216b in a subsequent process, and the second base material area 1214 may be an area to be slit and notched into a base material tab 1211 in the subsequent process. According to some embodiments, the rolling may include hot rolling or cold rolling, and a texture or roughness may be transferred to the first base material area 1213 by forming the texture or roughness on the rolling roller. In some embodiments, adhesive strength between the active material 1216a and 1216b and the first base material area 1213 may be improved. According to some embodiments, annealing and/or surface treatment processes may be further performed after rolling.

As illustrated in FIG. 9, in the process of coating an active material S3, active materials 1216a and 1216b may be applied to the first base material area 1213. As described above, if a positive electrode plate is manufactured, a positive active material may be coated, and if a negative electrode plate is manufactured, a negative active material may be coated. According to some embodiments, the coating may be performed in a manner, in which slurry-type active materials 1216a and 1216b are uniformly applied to the first base material area 1213 by a slot die. The active materials 1216a and 1216b in the form of slurry may be applied on the first base material area 1213, and then the slurry may flow to the second base material area 1214 to cover a portion of the second base material area 1214. In some embodiments, the active materials 1216a and 1216b in the form of the slurry may be coated to a portion of the second base material area 1214 that is slightly beyond the stepped portions 1215a and 1215b, each of the stepped portions acting as a dam. In some embodiments, the active materials 1216a and 1216b may minimize an active material dragging phenomenon (e.g., a phenomenon in which an end of the active material is thin and long) due to the stepped portions 1215a and 1215b. After the coating, the active materials 1216a and 1216b may be firmly attached to the first base material area 1213 through drying and roll pressing processes. According to some embodiments, the active materials 1216a and 1216b may be applied to the first base material area 1213 in a matrix form having rows and columns, or the active materials 1216a and 1216b may be applied to the entire first base material area 1213. As described above, a thickness of each of the active materials 1216a and 1216b may range of about 50 μm to about 120 μm.

As illustrated in FIG. 10, in the process of slitting and notching the electrode plate S4, a first base material area 1213 coated with the active materials 1216a and 1216b and a second base material area 1214 to be used as the base material tab 1211 may be slit and notched from the conductive base material 1212 so that an individual electrode plate is provided. For convenience of understanding, the area to be slit and notched are illustrated in dotted lines in FIG. 10.

According to some embodiments, a portion of the first base material area 1213 coated with the active material may be cut from the conductive base material 1212 so as to be fit for specifications of the first electrode plate 121, the electrode plate being formed by a slitter. Thereafter, a portion to be used as a base material tab 1211 may be cut from the second base material area 1214 by a laser or press notching device.

Through the slitting and notching process, the first electrode plate 121 may have a size and shape that are suitable for the electrode assembly 120, and then separated individual first electrode plates 121 may be assembled into the electrode assembly 120.

In some embodiments, the first base material area 1213 on which the active materials 1216a and 1216b are applied may have a relatively thin thickness, and the second base material area 1214 used as the base material tab 1211 may have a relatively thick thickness. Thus, because the first base material area 1213 is relatively thin, it may be advantageous in terms of energy density, and, because the second base material area 1214 is relatively thick, it may be advantageous in terms of welding the second base material area 1214 with the electrode tab.

In some embodiments, the active materials 1216a and 1216b may not be separated from the stepped portions 1215a and 1215b between the first base material area 1213 and the second base material area 1214 and may cover the stepped portions 1215a and 1215b, respectively, and also may even cover a portion of the second base material area 1214.

In some embodiments, in the process of applying the active material 1216a and 1216b, the slurry-type active materials 1216a and 1216b may cause a problem involving a dragging phenomenon near the edge of the active material, and, thus, in the stack type electrode assembly 120, the thickness of each of the active materials 1216a and 1216b on the base material tab 1211 may be relatively very thin and long. To solve this problem, in the present disclosure, the thick active materials 1216a and 1216b may extend up to a partial area of the base material tab 1211 so that the thickness of the coating area is uniform overall.

Thus, according to some embodiments, a difference in thickness in the conductive base material 1212 may be provided, and, thus, the thin and long active material coating portion on the base material tab 1211 may be thickly supplemented. As a result, it may be possible to manufacture a secondary battery having the uniform energy density and high reliability by maintaining a thickness of the coating portion of an entirety of the first electrode plate 121 to be flat as possible.

As illustrated in FIG. 10, in the post-processing process S5, which may occur after the process of slitting and notching the electrode plate, the first electrode plate 121 may be completed as a final product through additional post-processing processes (e.g., washing, precision inspection, etc.) as necessary. After the post-processing process, the first electrode plate 121 may be input into the assembly process of a stack electrode assembly or a Z stack.

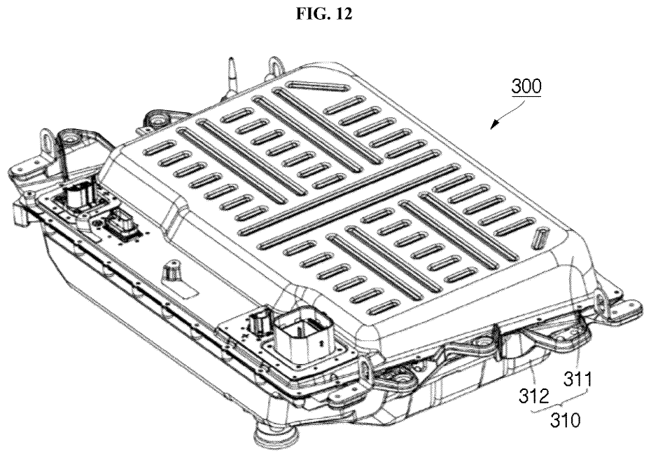

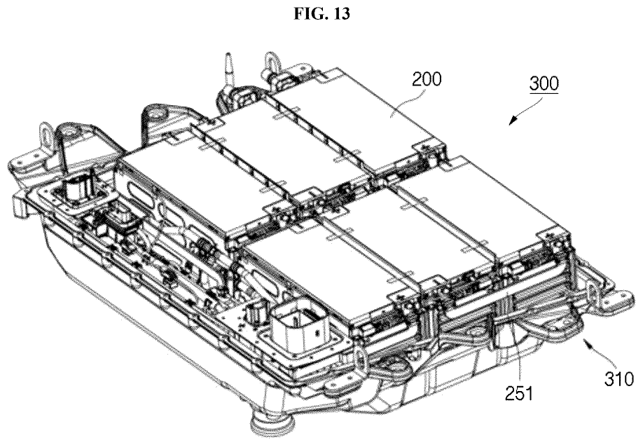

FIGS. 12 and 13 are perspective views showing a battery pack 300 including the secondary battery according to some embodiments. Referring to FIGS. 12 and 13, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 12 and 13, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

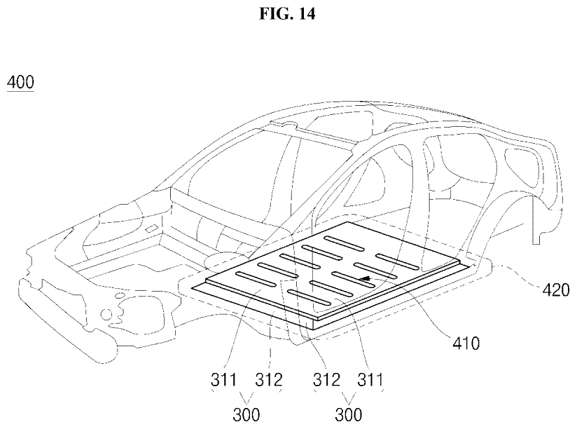

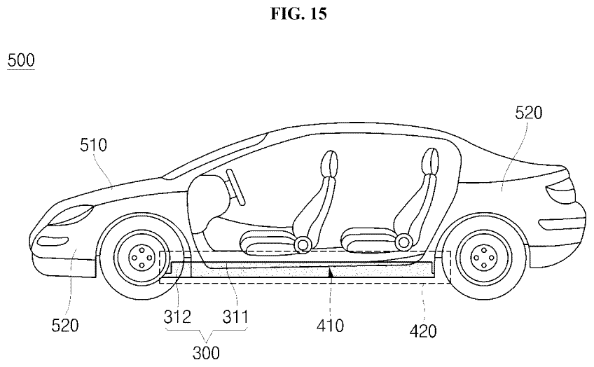

FIGS. 14 and 15 are perspective and side views showing vehicles 400 and 500 including the battery pack 300 according to some embodiments. In FIG. 14, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 15, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

According to some embodiments, the secondary battery, in which the thickness of the base material of the active material coating portion is reduced to improve energy density thereof, may be provided. According to some embodiments, the secondary battery, in which the base material portion serving as the function of the base material tab is maintained to have thick structure to improve the welding reliability with the electrode tab and reduce the defects during welding, may be provided. According to some embodiments, the secondary battery, in which an active material dragging phenomenon (whereof a coating thickness is thin and long at the end of an active material coating portion) is suppressed so that the thickness of the active material coating portion is flat overall, thereby preventing a lithium precipitation phenomenon from occurring, may be provided.

However, aspects and features of the present disclosure are not limited to those described above, and other aspects and features not mentioned will be clearly understood by a person skilled in the art from the detailed description, described above.

Although the present disclosure has been described above with limited examples and drawings, the present disclosure is not limited thereto, and it is obvious that various modifications and variations may be made by those skilled in the art in the technical field to which the present disclosure belongs within the technical idea of the present disclosure.

What is claimed is:

1. A secondary battery comprising:
a case; and
an electrode assembly accommodated in the case, the electrode assembly comprising a first electrode plate, a second electrode plate, and a separator between the first electrode plate and the second electrode plate,
wherein at least one of the first electrode plate or the second electrode plate of the electrode assembly comprises:
a conductive base material; and
an active material applied to the conductive base material,
wherein the conductive base material comprises:
a first base material area coated with the active material and having a first thickness; and
a second base material area not coated with the active material and having a second thickness greater than the first thickness.

2. The secondary battery as claimed in claim 1, wherein the active material is configured to extend from the first base material area to the second base material area.

3. The secondary battery as claimed in claim 1, wherein a stepped portion is provided between the first base material area and the second base material area.

4. The secondary battery as claimed in claim 3, wherein the active material is configured to cover the stepped portion.

5. The secondary battery as claimed in claim 1, wherein the active material comprises a thickness reduction area having a thickness gradually decreasing from the first base material area to the second base material area.

6. The secondary battery as claimed in claim 5, wherein a stepped portion, covered by the thickness reduction area, is provided between the first base material area and the second base material area.

7. The secondary battery as claimed in claim 5, wherein a width of the thickness reduction area is from about 8 μm to about 12 μm.

8. The secondary battery as claimed in claim 1, wherein a ratio of a thickness of the first base material area and a thickness of the second base material area is from about 0.5:1 to about 0.9:1.

9. The secondary battery as claimed in claim 1, wherein the conductive base material comprises copper or aluminum.

10. The secondary battery as claimed in claim 1, wherein the conductive base material comprises:
a first surface; and
a second surface opposite of the first surface,
wherein the active material is applied to at least one of the first surface and the second surface.

11. The secondary battery as claimed in claim 1, wherein the second base material area comprises a base material tab welded to an electrode tab.

12. The secondary battery as claimed in claim 1, wherein the second base material area is welded to an electrode tab inside of the case, and wherein the electrode tab extends outside of the case.

13. A method of manufacturing an electrode plate of an electrode assembly for a secondary battery, the method comprising:
providing a conductive base material;
rolling the conductive base material to provide a first base material area having a thickness, with a second base material area of the conductive base material being thicker than the first base material area and being outside the first base material area;
applying an active material to the first base material area; and
slitting and notching the first base material area and the second base material area to form an individual electrode plate.

14. The method as claimed in claim 13, wherein applying the active material to the first base material area further comprises extending the active material from the first base material area to the second base material area.

15. The method as claimed in claim 13, further comprising providing a stepped portion between the first base material area and the second base material area.

16. The method as claimed in claim 15, further comprising configuring the active material to cover the stepped portion.

17. The method as claimed in claim 13, further comprising configuring the active material to have a thickness reduction area, where a thickness of the active material gradually decreases from the first base material area to the second base material area.

18. The method as claimed in claim 17, further comprising providing, between the first base material area and the second base material area, a stepped portion, which is covered by the thickness reduction area.

19. The method as claimed in claim 13, wherein the conductive base material comprises a first surface and a second surface opposite of the first surface, the method further comprising applying the active material to at least one of the first surface and the second surface.

20. The method as claimed in claim 13, further comprising selecting the conductive base material such that the conductive base material comprises copper or aluminum.
